(19) United States
(12) Patent Application Publication
(10) Pub. No.: US 2016/0338116 A1
(43) Pub. Date: Nov. 17, 2016

(54) ESTABLISHING A RADIO CONNECTION IN A RADIO COMMUNICATIONS NETWORK

(71) Applicant: Telefonaktiebolaget LM Ericsson (Publ), Stockholm (SE)

(72) Inventors: Andreas BERGSTRÖM, Vikingstad (SE); Erik ERIKSSON, Linköping (SE); Håkan PALM, Växjö (SE); Paul SCHLIWA-BERTLING, Ljungsbro (SE); Kai-Erik SUNELL, Bromma (SE)

(73) Assignee: Telefonaktiebolaget LM Ericsson (Publ), Stockholm (SE)

(21) Appl. No.: 15/110,800

(22) PCT Filed: Dec. 11, 2014
(86) PCT No.: PCT/SE2014/051488

§ 371 Date: Jul. 11, 2016

Related U.S. Application Data
(60) Provisional application No. 61/932,271, filed on Jan. 28, 2014.

(51) Int. Cl. H04W 76/02; H04W 28/06; H04W 48/10

(52) U.S. Cl. CPC H04W 76/021; H04W 48/10; H04W 28/06

(57) ABSTRACT

A method performed by a user equipment for requesting a radio connection with a network node in a radio communications network is provided. The user equipment is configured to be in the radio communications network. The user equipment configures a request message for setting up a radio connection to a network node to comprise an indication indicating whether the user equipment has one or more differing user equipment radio capabilities in relation to another user equipment configured to be in the radio communications network and send the configured request message to the network node. A user equipment for requesting a radio connection with a network node in a radio communications network is also provided. A network node for enabling a radio connection with a user equipment in a radio communications network and a method performed therein are also provided.

### TECHNICAL FIELD

Embodiments herein relate to radio connections in a radio communications network. In particular, embodiments herein relate to a user equipment for requesting a radio connection to a network node and a network node for enabling a radio connection with the user equipment, and methods therein.

### BACKGROUND

In a typical radio communications network, wireless terminals, also known as mobile stations and/or user equipments, UEs, communicate via a Radio Access Network, RAN, to one or more core networks. The radio access network covers a geographical area which is divided into cell areas, with each cell area being served by a base station, e.g. a radio base station, RBS, which in some networks may also be called, for example, a “NodeB” or “eNodeB”. A cell is a geographical area where radio coverage is provided by the radio base station at a base station site or an antenna site in case the antenna and the radio base station are not collocated. Each cell is identified by an identity within the local radio area, which is broadcast in the cell. Another identity identifying the cell uniquely in the whole mobile network is also broadcasted in the cell. One base station may have one or more cells. A cell may be downlink and/or uplink cell. The base stations communicate over the air interface operating on radio frequencies with the user equipments within range of the base stations.

A Universal Mobile Telecommunications System, UMTS, is a third generation mobile communication system, which evolved from the second generation, 2G, Global System for Mobile Communications, GSM. The UMTS terrestrial radio access network, UTRAN, is essentially a RAN using wideband code division multiple access, WCDMA, and/or High Speed Packet Access, HSPA, for user equipments. In a forum known as the Third Generation Partnership Project, 3GPP, telecommunications suppliers propose and agree upon standards for third generation networks and UTRAN specifically, and investigate enhanced data rate and radio capacity. In some versions of the RAN as e.g. in UMTS, several base stations may be connected, e.g., by landlines or microwave, to a controller node, such as a radio network controller, RNC, or a base station controller, BSC, which supervises and coordinates various activities of the plural base stations connected thereto. The RNCs are typically connected to one or more core networks.

Specifications for the Evolved Packet System, EPS, have been completed within the 3^{rd} Generation Partnership Project, 3GPP, and this work continues in the coming 3GPP releases. The EPS comprises the Evolved Universal Terrestrial Radio Access Network, E-UTRAN, also known as the Long Term Evolution, LTE, radio access, and the Evolved Packet Core, EPC, also known as System Architecture Evolution, SAE, core network. E-UTRAN/LTE is a variant of a 3GPP radio access technology wherein the radio base station nodes are directly connected to the EPC core network rather than to RNCs. In general, in E-UTRAN/LTE the functions of a RNC are distributed between the radio base stations nodes, e.g. eNodeBs in LTE, and the core network. As such, the Radio Access Network, RAN, of an EPS has an essentially “flat” architecture comprising radio base station nodes without reporting to RNCs.

In 3GPP discussions, such as, e.g. in 3GPP TR 36.388 “Study on provision of low-cost Machine-Type Communications (MTC) User Equipment's (UEs) based on LTE”, there has recently been several proposals on how to reduce the complexity of and, hence, the cost of an LTE UE. These devices are commonly referred to as low-cost LTE devices, that is, LTE UEs which have limited radio capabilities as compared to conventional or regular LTE UEs. These limited radio capabilities may be, for example, be maximum allowed Transport Block Sizes, TBS; maximum allowed bandwidths, etc.

It follows that a base station in a radio communications network needs thus be able to make a distinction between these two categories of accessing LTE UEs, and also be able to be informed about the actual limitations of radio capabilities for each specific accessing LTE UE. This, in order to be able to perform a suitable radio communication with UEs in each category, that is, adjust certain radio control parameters, such as, e.g. scheduling, power control, handover procedure, etc., differently with regards to the different LTE UEs.

This information may be provided by the accessing LTE UE to the base station using RRC signalling after the radio connection has been set up, i.e. after having completed the Radio Resource Control, RRC, Connection Setup procedure. For example, this may be done by the base station by either requesting the LTE UE capabilities from a Mobility Management Entity, MME, if this information has already been cached, or by explicitly requesting this information from the connected LTE UE.

### SUMMARY

It is an object of embodiments herein to improve the performance of radio communication in the radio communications network.

According to a first aspect of embodiments herein, the object is achieved by a method performed by a user equipment for requesting a radio connection with a network node in a radio communications network. The user equipment is configured to be in the radio communications network. The user equipment configures a request message for setting up a radio connection to a network node to comprise an indication indicating whether the user equipment has one or more differing user equipment radio capabilities in relation to another user equipment configured to be in the radio communications network. Then, the user equipment sends the configured request message to the network node.

According to a second aspect of embodiments herein, the object is achieved by a user equipment for requesting a radio connection with a network node in a radio communications network. The user equipment is configured to be in the radio communications network. The user equipment is further configured to configure a request message for setting up a radio connection to a network node to comprise an indication indicating whether the user equipment has one or more differing user equipment radio capabilities in relation to another user equipment configured to be in the radio communications network. The user equipment is also further configured to send the configured request message to the network node.

According to a third aspect of embodiments herein, the object is achieved by a method performed by a network node for enabling a radio connection with a user equipment in a radio communications network. The network node is configured to be in the radio communications network. The network node receives a request message for setting up a radio connection from the user equipment comprising an indication indicating whether the user equipment has one or more differing user equipment radio capabilities in relation to another user equipment configured to be in the radio communications network.

According to a fourth aspect of embodiments herein, the object is achieved by a network node for enabling a radio connection with a user equipment in a radio communications network. The network node is configured to be in the radio communications network. The network node is further configured to receive a request message for setting up a radio connection from the user equipment comprising an indication indicating whether the user equipment has one or more differing user equipment radio capabilities in relation to another user equipment configured to be in the radio communications network.

By having information regarding a differing user equipment radio capability of a UE available at the network node as early as upon making the request for setting up a radio connection, the network node is enabled to adjust the use of radio resources during the radio connection setup procedure in view of the differing user equipment radio capability of the UE, which may potentially be a limited user equipments radio capability of the UE. This instead of, for example, assuming that all UEs, even the more capable UEs, have the same limited set of radio capabilities or that all UEs have the same non-limited set of radio capabilities which may result in that UEs with limited set of radio capabilities are not able to receive all radio connection setup messages from the network node.

Hence, the radio connection setup procedure is improved, whereby the performance of the radio communication in the radio communications network is improved.

### BRIEF DESCRIPTION OF THE DRAWINGS

Features and advantages of the embodiments will become readily apparent to those skilled in the art by the following detailed description of exemplary embodiments thereof with reference to the accompanying drawings, wherein:

FIG. 1 is a signalling diagram depicting an RRC connection setup procedure.

FIG. 2 is a schematic block diagram illustrating embodiments in a radio communications network.

FIG. 3 is a flowchart depicting embodiments of a method in a user equipment.

FIG. 4 is a flowchart depicting embodiments of a method in a network node.

FIG. 5 is a block diagram depicting embodiments of a user equipment.

FIG. 6 is a block diagram depicting embodiments of a network node.

### DETAILED DESCRIPTION

The figures are schematic and simplified for clarity, and they merely show details which are essential to the understanding of the embodiments presented herein, while other details have been left out. Throughout, the same reference numerals are used for identical or corresponding parts or steps.

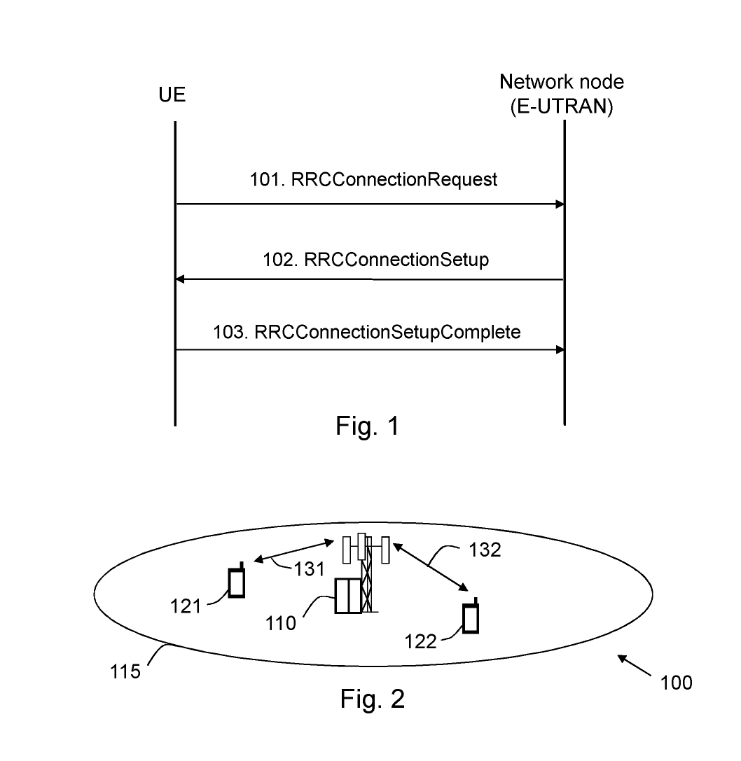

FIG. 1 shows the current RRC Connection Setup procedure in the Evolved Universal Terrestrial Radio Access Network, E-UTRAN, as defined in the specification 3GPP TS 36.331 “Evolved Universal Terrestrial Radio Access (E-UTRA); Radio Resource Control (RRC); Protocol Specification”.

In Action 101, the UE sends a request message, RRCConnectionRequest message (MSG 3), to the network node in the access network, i.e. E-UTRAN. According to 3GPP TS 36.331, this message may be defined as shown in Table 1 below.

TABLE 1
-- ASN1START

| | |
|---|---|
| RRCConnectionRequest ::= | SEQUENCE { |

| | |
|---|---|
| criticalExtensions | CHOICE { |

| | |
|---|---|
| rrcConnectionRequest-r8 | RRCConnectionRequest-r8-IEs, |
| criticalExtensionsFuture | SEQUENCE { } |

}

}

| | |
|---|---|
| RRCConnectionRequest-r8-IEs ::= | SEQUENCE { |

| | |
|---|---|
| ue-Identity | InitialUE-Identity, |
| establishmentCause | EstablishmentCause, |
| spare | BIT STRING (SIZE (1)) |

}

| | |
|---|---|
| InitialUE-Identity ::= | CHOICE { |

| | |
|---|---|
| s-TMSI | S-TMSI, |
| randomValue | BIT STRING (SIZE (40)) |

}

| | |
|---|---|
| EstablishmentCause ::= | ENUMERATED { |

emergency, highPriorityAccess, mt-Access, mo-

Signalling,

mo-Data, delayTolerantAccess-v1020, spare2, spare1}

-- ASN1STOP

In the RRCConnectionRequest message (MSG 3), the IntitialUE-Identity Information Element, IE, is constructed, as described in section 5.3.3.3 of 3GPP TS 36.331, by the SAE Temporary Mobile Subscription Identity, S-TMSI, if such has been provided by higher layers. Otherwise, a random number in the range 2⁴⁰-1 is used.

The S-TMSI in turn is defined as described in section 2 of 3GPP TS 23.003 as <S-TMSI>=<MMEC>+<M-TMSI>, where MMEC is an 8 bit MME Code and the M-TMSI is a 32 bit temporary identity assigned by the Mobility Management Entity, MME.

In Action 102, the network node in the E-UTRAN network may, in case of accepting the radio connection from the UE, respond with a setup message, RRCConnectionSetup message (MSG4).

In Action 103, the UE responds with a setup complete message, RRCConnectionSetupComplete message (MSG5).

With this in mind, as part of the developing of the embodiments described herein, a problem will first be identified and discussed.

One problem with providing information regarding limitations in the user equipment radio capabilities of a UE after the RRC connection setup procedure has been completed may be that it is not certain that all the messages exchanged during the RRC connection setup procedure are able to be received by the UE. For example, the message may not be within the capability limitations of the UE, e.g. as set by a maximum TBS or bandwidth.

A first solution to this problem would be to treat every accessing device as being a UE with limited user equipment radio capabilities, e.g. a low-cost LTE device. This implies using the strictest level of limitations that are possible for a UE throughout the entire RRC connection setup procedure for all UEs. This means, for example, that a network node will be configured to assume that no UE is capable of receiving specific radio connection setup messages, such as, e.g. a RRC Connection Setup message (MSG4), which are larger than this limitation. Unfortunately, this may significantly deteriorate or reduce the resource efficiency of the network, since many capable UEs, e.g. non-low-cost/regular/conventional LTE-devices, are actually able to receive such messages. More specifically, the performance of the RRC Connection Setup procedure will be reduced, since all capable UEs will not use the physical radio channels in an optimal way. Furthermore, the information which is not possible to fit into these messages needs to be provided later using explicit RRC signalling between the UE and the network node, which puts an additional transmission load on the radio resources in the radio network.

Another second solution that has been proposed in 3GPP discussions is to dedicate a specific subset of preambles in the Physical Random Access CHannel, PRACH, in a cell and/or time/frequency resources of the PRACH in a cell solely to be used by the UEs with limited user equipment radio capabilities for this information. While this would provide the network with information on the nature of the accessing device earlier than the first solution, the network would however still not know the specific limitations in the user equipment radio capabilities associated with the specific UE accessing the network. Also, this will lead to segregation, and a potential trunking loss, of RACH resources, and also the potential need for making the planning of the Physical Cell-Id, PCI, even more complex.

It should also be noted that none of the solutions described above are viable and easily extendable solution which may apply to other types of accessing device categories, such as, UEs according to upcoming future releases with potentially increased user equipment radio capabilities. For example, according to the first solution, not only existing capable UEs but also more capable future UEs will need to be treated as being simpler than they are, i.e. as having limited user equipment radio capabilities. Also, in another example according to the second solution, the new set of RACH resources needs to be dedicated and will apply to each and every future UE type, which is hardly feasible.

In view of the problems discussed above and when developing of the embodiments described herein, it has been noticed that there is a large potential gain in being able to provide the information that the UE has limited user equipment radio capabilities from UE to network at as early as possible in the radio communication, since this may be used to avoid a non-optimal use of system and UE resources during the RRC Connection Setup procedure. Furthermore, it would also be quite beneficial to, at an earlier stage, let the network be informed on the radio capabilities of the accessing device. These issues are addressed by embodiments described herein, which are exemplified and explained in more detail below with reference to FIGS. 2-6.

FIG. 2 depicts a radio communications network 100 in which embodiments herein may be implemented. In some embodiments, the radio communications network 100 may be a wireless communications network such as an Long Term Evolution (LTE) or LTE-Advanced, or any other similar cellular network or system. The radio communication network 100 is exemplified herein as an LTE network.

The radio communications system 100 comprises a network node 110. The network node 110 serves at least one cell 115. The network node 110 may e.g. be a base station, a radio base station, eNB, eNodeB, a Home Node B, a Home eNode B, femto Base Station (BS), pico BS or any other network unit capable to capable of communicating with a user equipment within the cell served by the network node depending e.g. on the radio access technology and terminology used. The network node 110 may also be e.g. a base station controller, a network controller, a relay node, a repeater, an access point, a radio access point, a Remote Radio Unit (RRU) or a Remote Radio Head (RRH).

A cell is a geographical area where radio coverage is provided by radio base station equipment at a base station site or at remote locations in Remote Radio Units (RRU). The cell definition may also incorporate frequency bands and radio access technology used for transmissions, which means that two different cells may cover the same geographical area but using different frequency bands. Each cell is identified by an identity within the local radio area, which is broadcast in the cell. Another identity identifying the cell 115 uniquely in the whole radio communication network 100 is also broadcasted in the cell 115. The network node 110 communicates over the air or radio interface operating on radio frequencies with the UEs within range of the network node 110.

In FIG. 2, a first and a second user equipment 121, 122 are located within the cell 115. The first and second UE 121, 122 are configured to communicate within the radio communications network 100 via the network node 110 over a radio link 131, 132, respectively, when present in the cell 115 served by the network node 110. The first and second UE 121, 122 may e.g. be any kind of wireless device such as a mobile phone, a cellular phone, a Personal Digital Assistant (PDA), a smart phone, a tablet, a sensor equipped with a UE, Laptop Mounted Equipment (LME) (e.g. USB), Laptop Embedded Equipment (LEE), Machine Type Communication (MTC) device, or Machine to Machine (M2M) device, Customer Premises Equipment (CPE), etc.

However, in this example, the first UE 121 is a UE with limited user equipment radio capabilities, e.g. a so-called low cost LTE device, while the second UE 122 is a UE with non-limited user equipment radio capabilities, e.g. a non-limited/regular/conventional LTE device. This means that the first UE 121 has a set of radio capabilities that are limited in regards to the set of radio capabilities of the second UE 122. This limitation may, for example, comprise a maximum Transport Block Size (TBS), a maximum bandwidth, etc. which the first UE 121 is limited to using.

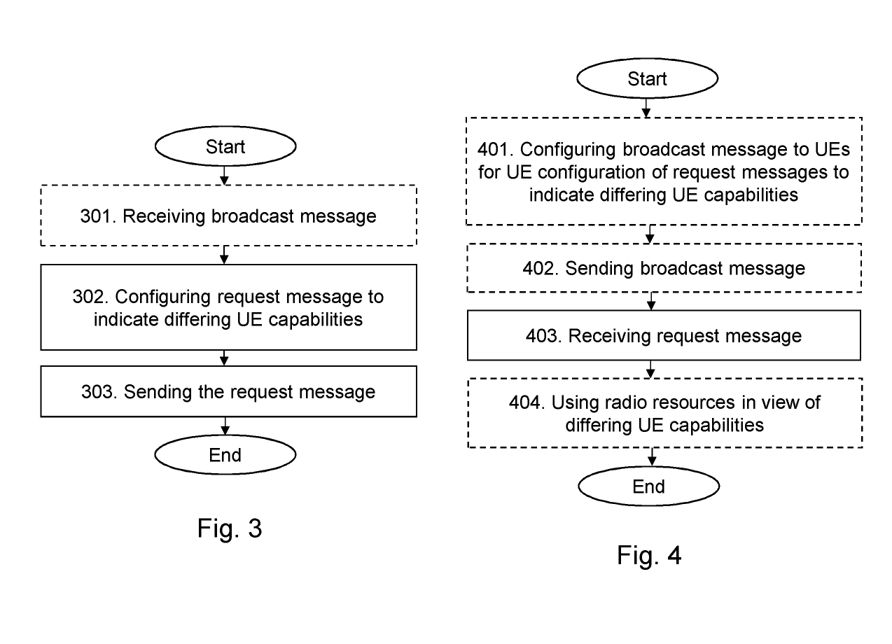

Example of embodiments of a method performed by a user equipment 121 for requesting a radio connection with a network node 110 in a radio communications network 100, will now be described with reference to a flowchart depicted in FIG. 3. Here, the user equipment 121 is configured to be in the radio communications network 100. FIG. 3 is an illustrated example of exemplary actions or operations which may be taken by the user equipment 121. The method may comprise the following actions.

Action 301

In this optional action, the user equipment 121 may receive a broadcast message from the network node 110. That is, the user equipment 121 may receive information in a broadcast message from the network node 110 indicating that the user equipment 121 is to perform a configuration according to Action 302, as described below, and a sending according to Action 303, as described below, when setting up a radio connection to the network node 110. In this way, the user equipment 121 may be informed by the network node 110 that the network node 110 has the capability to adjust the use of radio resources, e.g. its radio connection setup messages during the setup of the radio connection, in view of the differing user equipment radio capabilities of the user equipment 121. In response to receiving this information, the user equipment 121 may perform the Actions 302-303 described below upon setting up a radio connection with the network node 110.

This may also ensure that the user equipment 121 capable of the RRC Connection Setup procedure according to Action 302-303, as described below, does not cause problems in a legacy radio communications network, i.e. a radio communication network comprising network nodes 110 not adapted to receive messages according to this procedure. Hence, in some embodiments, the user equipment 121 may refrain from performing the RRC Connection Setup procedure according to Action 302-303 unless the broadcast message is received from the network node 110.

Action 302

In this action, the user equipment 121 configures a request message for setting up a radio connection to a network node 110 to comprise an indication indicating whether the user equipment 121 has one or more differing user equipment radio capabilities in relation to another user equipment 122 configured to be in the radio communications network 100. This enables the user equipment 121 to inform the network node 110 as early as possible, i.e. when making the request for setting up a radio connection, about the differing user equipment radio capabilities of the user equipment 121, e.g. as early as in the RRCConnectionRequest message (MSG 3).

It should be noted that any transmitted RRC Message, such as e.g. the RRCConnectionRequest message, will be sent through the RLC layer and hence will be encapsulated in an RLC PDU. Some RRC signaling employ transparent mode RLC and have no header while other RRC signaling employ RLC acknowledged mode with an accompanying RLC header. The RLC PDU in turn is then passed through the MAC layer and will be encapsulated in a MAC PDU with an accompanying MAC header. Hence, any information to be communicated on an RRC level, as described in the embodiments below, may then—as a complement of actually be encoded in the RRC message itself—equally well be included in the RLC layer, e.g. in the RLC header, and/or in the MAC layer, e.g. in the MAC header. For example, a RRCConnectionRequest message comprise 8 bits MAC header and 48 bits RRC information element.

In some embodiments, the request message is a RRCConnectionRequest message in a Evolved Universal Terrestrial Radio Access Network, E-UTRAN, RRC Connection Setup procedure. For example, this may be a request message as defined in the current RRC Connection Setup procedure in the Evolved Universal Terrestrial Radio Access Network, E-UTRAN, as defined in the specification 3GPP TS 36.331 “Evolved Universal Terrestrial Radio Access (E-UTRA); Radio Resource Control (RRC); Protocol Specification”.

In some embodiments, the user equipment 121 may configure the indication using a criticalExtensionFuture Information Element, IE, in the RRCConnectionRequest message. This IE may thus be used by the user equipment 121 to provide the indication to the network node 110 as to whether or not the user equipment 121 is a user equipment with limited user equipment radio capabilities.

An example of usage of the criticalExtensionFuture IE in the RRCConnectionRequest message may be seen below in Table 2 (wherein the modifications as compared to a conventional RRCConnectionRequest message is shown in bold):

TABLE 2
ASN1START

| | |
|---|---|
| RRCConnectionRequest ::= | SEQUENCE { |

| | |
|---|---|
| criticalExtensions | CHOICE { |

| | |
|---|---|
| rrcConnectionRequest-r8 | RRCConnectionRequest-r8-IEs, |

criticalExtensionsFuture CHOICE {

| rrcConnectionRequest-r12 RRCConnectionRequest-r12-Ies | |
|---|---|
| criticalExtensionsFuture | SEQUENCE { } |

}

}

}

| RRCConnectionRequest-r8-Ies ::= | | SEQUENCE { |
|---|---|---|
| | ue-Identity | InitialUE-Identity, |
| | establishmentCause | EstablishmentCause, |
| | spare | BIT STRING (SIZE (1)) |

}
RRCConnectionRequest-r12-Ies ::= SEQUENCE {

ue-Identity InitialUE-Identity,
establishmentCause EstablishmentCause

}

| InitialUE-Identity ::= | | CHOICE { |
|---|---|---|
| | s-TMSI | S-TMSI, |
| | randomValue | BIT STRING (SIZE (40)) |

}

| | |
|---|---|
| EstablishmentCause ::= | ENUMERATED { |
| | emergency, highPriorityAccess, mt-Access, |

mo-Signalling,

mo-Data, delayTolerantAccess-v1020,

spare2, spare1}
-- ASN1STOP

Optionally, in some embodiments, the user equipment 121 may configure the indication as a dedicated RRCConnectionRequest message defined in a message on the Uplink Common Control CHannel, UL-CCCH-Message, used for transporting RRCConnectionRequest messages. This means creating a new request message that may be used by the user equipment 121 to provide the indication to the network node 110 as to whether or not the user equipment 121 is user equipment with limited user equipment radio capabilities. For example, the reception of this request message could indicate to a network node 110 that the user equipment 121 is not a conventional/regular/non-limited user equipment, i.e. that the user equipment 121 is user equipment with limited user equipment radio capabilities. The UL-CCCH-Message class is the set of RRC messages that may be sent from the user equipment 121 to the network node 110 on the uplink CCCH logical channel.

An example of a message on the Uplink Common Control CHannel, UL-CCCH-Message, defining this new request message may be seen below in Table 3 (wherein the modifications as compared to a conventional RRCConnectionRequest message is shown in bold):

TABLE 3
-- ASN1START
UL-CCCH-Message ::= SEQUENCE {

| | |
|---|---|
| message | UL-CCCH-MessageType |

}
UL-CCCH-MessageType ::= CHOICE {

| | |
|---|---|
| c1 | CHOICE { |

rrcConnectionReestablishment Request

RRCConnectionReestablishmentRequest,

rrcConnectionRequest

RRCConnectionRequest

},

messageClassExtension CHOICE {

| rrConnectionRequest-r12 RRCConnectionRequest-r12, | |
|---|---|
| messageClassExtensionFuture [symbol] | SEQUENCE { } |

}

}
-- ASN1STOP

This means that the actual content of this new request message, denoted above as RRCConnectionRequestR12, may be adapted to what is needed. As an example, one may use something close to identical to the RRCConnectionRequest as may be seen below in Table 4 (wherein the modifications as compared to a conventional RRCConnectionRequest message is shown in bold):

TABLE 4
ASN1START

| RRCConnectionRequest-r12 ::= | | SEQUENCE { |
|---|---|---|
| | criticalExtensions | CHOICE { |

[symbol]

rrcConnectionRequest-r12 RRCConnectionRequest-r12-IEs,
criticalExtensionsFuture SEQUENCE { }

}

}

[symbol]

[symbol]

[symbol]

[symbol]

[symbol]

RRCConnectionRequest-r12-IEs ::= SEQUENCE {

ue-Identity InitialUE-Identity,
establishmentCause EstablishmentCause

}
-- ASN1STOP

Since this is a dedicate new request message, there is of course full freedom to use and/or reuse the information bits to e.g. remove or change the meaning of the EstablishmentCause IE or reducing the number of information bits used for the InitialUE-Identity IE, etc. It may however be suitable to keep the total size of the message fairly constant, i.e. close to the current total size of the original RRCConnectionRequest message, and also reuse the existing IEs, such as, e.g. the EstablishmentCause IE when possible.

In some embodiments, the user equipment 121 may configure the request message such that the indication further indicates at least one of the one or more differing user equipment radio capabilities. This enables the user equipment 121 not only to inform the network node 110 that it has one or more differing user equipment radio capabilities, but also what this or these differing user equipment radio capabilities are comprised of. For example, the first UE 121 with limited user equipment radio capabilities, e.g. in the form of a maximum Transport Block Sizes (TBS), a maximum bandwidths, etc., as compared to second UE 122 may thus inform the network node 110 about its limited user equipment radio capabilities. Consequently, this enables the network node 110 to adjust the use of radio resources, e.g. its radio connection setup messages during the setup of the radio connection, in view of the limited user equipment radio capabilities of the first UE 121.

In some embodiments, the user equipment 121 may replace information bits in the InitialUE-Identity IE in the RRCConnectionRequest message with information bits comprising the indication. This advantageously provides the indication to the network node 110 without any changes having to be made to the current RRC Connection Setup procedure or any additions to the transmission load in the radio communication network 100. That is, the user equipment 121 may use information bits that are not used by the network node 110 for any other purpose than providing a unique identifier during the RRC Connection Setup procedure. Hence, for example, it is also possible for the first UE 121 with limited user equipment radio capabilities to convey the specifics of the limitations associated with its limited user equipment radio capabilities in the request message, without actually increasing the size of this message.

For example, the RRCConnectionSetup message from the network node 110 to the user equipment 121 comprises the 40-bit long InitialUE-Identity IE. The purpose of this IE is to provide a unique key between the user equipment 121 and the network node 110 during the RRC Connection Setup procedure. Here, it has be noted in the case of when no S-TMSI has been provided to the user equipment 121, that the chances for contention failure or conflicts occurring will still be extremely low even if the random field would be, for example, 32 information bits long instead of using all of the 40 information bits. Hence, using e.g. 32 information bits, would free 8 information bits which may then be used by the user equipment 121 to convey the specific information associated with the limited user equipment radio capabilities of the user equipment 121.

In some embodiments, the replaced information bits are information bits which correspond to the Mobility Management Entity Code, MMEC. Advantageously, this is information in the InitialUE-Identity IE in the RRCConnectionRequest message is not used by the network node 110 until a later stage in the RRC Connection Setup procedure, i.e. not used by the network node 110 before or during the sending of the setup message, RRCConnectionSetup, in response to the request message from the user equipments 121. For example, in the case of when the S-TMSI has been provided to the user equipment 121, the 8 information bits corresponding to the MMEC is not needed until later, i.e. after the RRC Connection Setup has been completed. Hence, these 8 information bits may then be used by the user equipment 121 to convey the specific information associated with the limited user equipment radio capabilities of the user equipment 121.

An example of how to use a reduced InitialUE-Identity, which could be part of a RRCConnectionRequest-r12 IEs, may be seen below in Table 5:

TABLE 5

| RRCConnectionRequest-r12-IEs ::= | | SEQUENCE { |
|---|---|---|
| | additionalCapabilities | BIT STRING (SIZE (8)) |
| | reducedUE-Identity | ReducedInitialUE-Identity, |
| | establishmentCause | EstablishmentCause |

}

| ReducedInitialUE-Identity ::= | | CHOICE { |
|---|---|---|
| | m-TMSI | M-TMSI, |
| | randomValue | BIT STRING (SIZE (32)) |

}

The specific information associated with the limited user equipment radio capabilities of the user equipment 121, e.g. the capabilities and/or limitations which need to be signaled by a low-cost LTE device, is thus what may be comprised in what is referred to above as additionalCapabilities. It should further be noted that the size of 8 information bits above are merely mentioned as an example but could very well be other values, whereby the above IE construct may be adjusted accordingly (not shown).

It should also be noted that a further advantage of replacing these particular information bits, i.e. MMEC bits, is that they are a mandatory part, in case the user equipment 121 has this information, of the RRCConnectionSetupComplete sent by the user equipment 121 in response to the setup message, RRCConnectionSetup, from the network node 110 in the current RRC Connection Setup procedure. This described in the specification 3GPP TS 36.331, section 5.3.3.4 as follows (in particular by the emphasized parts):

1> set the content of RRCConnectionSetupComplete message as follows:
2> set the selectedPLMN-Identity to the PLMN selected by upper layers (see TS 23.122 [11], TS 24.301 [35]) from the PLMN(s) included in the plmn-IdentityList in SystemInformationBlockType1;
2> if upper layers provide the ‘Registered MME’, include and set the registeredMME as follows:
   3> if the PLMN identity of the ‘Registered MME’ is different from the PLMN selected by the upper layers:
      4> include the plmnIdentity in the registeredMME and set it to the value of the PLMN identity in the ‘Registered MME’ received from upper layers;
   3> set the mmegi and the mmec to the value received from upper layers;

This means that the missing information with regard to the S-TMSI, i.e. the information not provided in the RRCConnectionRequest (MSG3) as exemplified above as the MMEC information bits, is then comprised in the RRCConnectionSetupComplete (MSG5) message.

However, in some cases, when there is equipment using legacy technology wherein this information is not mandatory sent when present, a change in the presence of protocol fields could cause backward compatibility problems. This is because a receiving side that is based on a technology as described above would then expect that this field is present, while a transmitting side that is based on legacy technology may still leave this field absent. In such a case, a network node could discard the whole message at the receiving side, e.g. if LTE radio interface generic error handling procedures are strictly followed. Hence, one example of how this may be avoided is to add a new branch in the message, so that the presence of the field is changed from optional to mandatory present.

An example of such a message, i.e. the RRCConnectionSetupComplete (MSG5) message, may be seen below in Table 6 (wherein the modifications as compared to a conventional RRCConnectionSetupComplete message is shown in bold and underlined):

TABLE 6
-- ASN1START

| | |
|---|---|
| RRCConnectionSetupComplete ::= | SEQUENCE { |

| | |
|---|---|
| rrc-TransactionIdentifier | RRC-TransactionIdentifier, |
| criticalExtensions | CHOICE { |

| | |
|---|---|
| c1 | CHOICE{ |

| | |
|---|---|
| rrcConnectionSetupComplete-r8 | RRCConnectionSetupComplete-r8-IEs, |
| rrcConnectionSetupComplete-r12 | RRCConnectionSetupComplete-r12- |

IEs,,

spare2 NULL, spare1 NULL

| }, | |
|---|---|
| criticalExtensionsFuture | SEQUENCE { } |

}

}
RRCConnectionSetupComplete-r8-IEs ::= SEQUENCE {

| selectedPLMN-Identity | INTEGER (1..6), | |
|---|---|---|
| registeredMME | RegisteredMME | OPTIONAL, |

| dedicatedInfoNAS | DedicatedInfoNAS, | |
|---|---|---|
| nonCriticalExtension | RRCConnectionSetupComplete-v8a0-IEs | OPTIONAL |

}
RRCConnectionSetupComplete-v8a0-IEs ::= SEQUENCE {

| | | |
|---|---|---|
| lateNonCriticalExtension | OCTET STRING | OPTIONAL, |

| | |
|---|---|
| nonCriticalExtension | RRCConnectionSetupComplete-v1020-IEsOPTIONAL |

}
RRCConnectionSetupComplete-v1020-IEs ::= SEQUENCE {

| | |
|---|---|
| gummei-Type-r10 | ENUMERATED {native, mapped} |

| OPTIONAL, | | |
|---|---|---|
| rlf-InfoAvailable-r10 | ENUMERATED {true} | OPTIONAL, |
| logMeasAvailable-r10 | ENUMERATED {true} | OPTIONAL, |

| | | |
|---|---|---|
| rn-SubframeConfigReq-r10 | ENUMERATED {required, notRequired} | OPTIONAL, |
| nonCriticalExtension | SEQUENCE { } | OPTIONAL |

}
RRCConnectionSetupComplete-r12-IEs ::= SEQUENCE {

| | | |
|---|---|---|
| lateNonCriticalExtension | OCTET STRING | OPTIONAL, |

| | |
|---|---|
| selectedPLMN-Identity | INTEGER (1..6), |

registeredMME RegisteredMME OPTIONAL, --

Cond RedIdIE

| | |
|---|---|
| dedicatedInfoNAS | DedicatedInfoNAS, |

| | |
|---|---|
| gummei-Type-r10 | ENUMERATED {native, mapped} |

| OPTIONAL, | | |
|---|---|---|
| rlf-InfoAvailable-r10 | ENUMERATED {true} | OPTIONAL, |
| logMeasAvailable-r10 | ENUMERATED {true} | OPTIONAL, |

| | | |
|---|---|---|
| rn-SubframeConfigReq-r10 | ENUMERATED {required, notRequired} | OPTIONAL, |
| nonCriticalExtension | SEQUENCE { } | OPTIONAL |

}

| | |
|---|---|
| RegisteredMME ::= | SEQUENCE { |

| | | |
|---|---|---|
| plmn-Identity | PLMN-Identity | OPTIONAL, |

| | |
|---|---|
| mmegi | BIT STRING (SIZE (16)), |
| mmec | MMEC |

}
-- ASN1STOP

In this case, the following or similar explanation may be used to define the data field, such as, for example, shown below in Table 7:

TABLE 7

| Conditional presence | Explanation |
|---|---|
| RedIdIE | The field is mandatory present if the |
| | ReducedInitialUE-Identity IE was used |
| | in the preceding RRCConnectionRequest |
| | message; otherwise optionally present, |

Alternatively, in some embodiments, not the entire RegisteredMME IE may be set as mandatory, but could e.g. also be set to only the MMEC in this case. Furthermore, in case the number of information bits replaced from the RRCConnectionSetup message is another number than 8, as exemplified above, this may be into account and adjusted accordingly.

Action 303

After configuring the request message, the user equipment 121 sends the configured request message to the network node 110. This informs the network node 110 as early as possible, i.e. when making the request for setting up a radio connection, about the differing user equipment radio capabilities of the user equipment 121.

It should also be noted that in some embodiments, the user equipment 121 may send a conventional RRCConnectionRequest message without the indication in a E-UTRAN RRC Connection Setup procedure, when performing the Actions 302-303 described above upon setting up a radio connection with the network node 110 results in one or more failures of setting up the radio connection to the network node 110. Advantageously, this allows the user equipment 121 to fall-back to using a legacy RRC Connection Setup procedure in case the radio connection setup according to the embodiments described herein should fail.

Example of embodiments of a method performed by a network node 110 for enabling a radio connection with a user equipment 121 in a radio communications network 100, will now be described with reference to a flowchart depicted in FIG. 4. Here, the network node 110 is configured to be in the radio communications network 100. FIG. 4 is an illustrated example of exemplary actions or operations which may be taken by the network node 110. The method may comprise the following actions.

Action 403

In this optional action, the network node 110 may configure a broadcast message indicating to the user equipment 121 to configure a request message, when setting up a radio connection to the network node 110, to comprise the indication according to Action 403.

By indicating its capabilities on supporting this type of access by the user equipment 121, the network node 110 may prevent the user equipment 121 performing the RRC Connection Setup procedure as described in the embodiments above, from attempting to do so in a legacy radio communications network that is not capable of handling this information. In other words, by broadcasting this information to the user equipment 121, the user equipment 121 may be informed of whether or not it should perform the RRC Connection Setup procedure as described in the embodiments above.

For example, in such cases where the user equipment 121 attempts to do so in a legacy radio communications network that is not capable of handling this information, there is a risk that a legacy network node may misinterpret the new RRCConnectionRequest-r12-IEs as being the RRCConnectionRequest-r8-IEs, and hence the added additionalCapabilities IE as being the MMEC. However, generally, this should not be a problem since the MMEC is not really needed until after the contention resolution is completed, i.e. after the transmission of the RRCConnectionSetupComplete message (MSG5). Hence, whenever performing the RRC Connection Setup procedure as described in the embodiments above, performing the transmission of the MMEC in this message in the RRCConnectionSetupComplete message (MSG5) should be enough. This is also related to an additional cost, i.e. transmission load in the radio communication network 100, due to the mandatory transmission of the MMEC in the RRCConnectionSetupComplete message (MSG5), which may, in some cases, make this message unnecessarily large.

In some embodiments, the broadcast message may be comprised in a System Information Block, SIB or SIBx, or a Master Information Block, MIB. This means that the network node 110 may indicate its capabilities on supporting this type of access to the user equipment 121 in the broadcasted system information, for example, using one of the spare information bits in the MIB, or in an appropriate SIB (SIBx denotes a future version SIB).

An example of such a message, i.e. the MasterInformationBlock message, may be seen below in Table 8 (wherein the modifications as compared to a conventional MasterInformationBlock message are shown in bold and underlined):

TABLE 8
-- ASN1START

| MasterInformationBlock ::= | | SEQUENCE { |
|---|---|---|
| | dl-Bandwidth | ENUMERATED { |
| | | n6, n15, n25, n50, n75, n100}, |
| | phich-Config | PHICH-Config, |
| | systemFrameNumber | BIT STRING (SIZE (8)), |

[symbol]

r12RrcConnecionSetupSupported BIT STRING (SIZE (1))
spare BIT STRING (SIZE (9))

}
-- ASN1STOP

In this case, the following or similar explanation may be used to define the data field, such as, for example, shown below in Table 9:

TABLE 9
MasterInformationBlock field descriptions

r12RrcConnecionSetupSupported
If set, the usage of the modified RRC Connection Setup procedure for
release 12 is supported by the network and UEs capable thereof may use
this procedure. If not set, accessing UEs shall follow the release 8
procedures for RRC Connection Setup

Action 403

In this optional action, the network node 110 may send the configured broadcast message to the user equipment 121. Advantageously, this may provide the user equipment 121 with information about whether or not it should perform the RRC Connection Setup procedure as described in the embodiments above.

Action 403

In this action, the network node 110 receives a request message for setting up a radio connection from the user equipment 121 comprising an indication indicating whether the user equipment 121 has one or more differing user equipment radio capabilities in relation to another user equipment 122 configured to be in the radio communications network 100. This enables the network node 110 to be informed as early as possible about whether or not the user equipment 121 has differing user equipment radio capabilities, e.g. as early as in the RRCConnectionRequest message (MSG 3).

In some embodiments, the indication may further indicate at least one of the one or more differing user equipment radio capabilities. This enables the network node 110 to be informed as early as possible about any radio capability limitations associated with any differing user equipment radio capability of the user equipment 121.

Action 404

After receiving the request message, the network node 110 may use radio resources based on the indication when setting up the radio connection. In this way, the network node 110 may adjust the use of radio resources, e.g. its radio connection setup messages during the setup of the radio connection, in view of the differing user equipment radio capabilities of the user equipment 121.

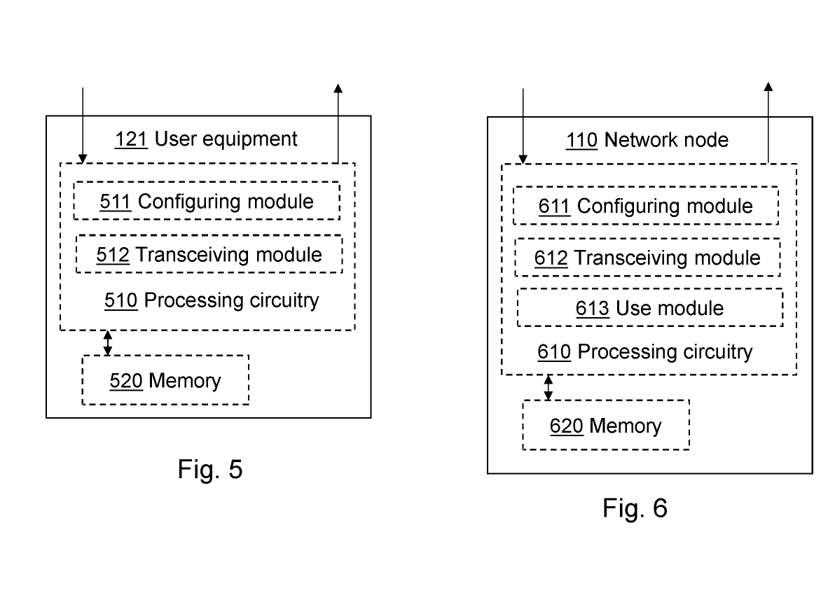

To perform the method actions in the user equipment 121 for requesting a radio connection with a network node 110 in a radio communications network 100, the user equipment 121 may comprise the following arrangement depicted in FIG. 5. The user equipment 121 is configured to be in the radio communications network 100.

FIG. 5 shows a schematic block diagram of embodiments of the user equipment 121. In some embodiments, the user equipment 121 may comprise a configuring module 511 and a transceiving module 512. In some embodiments, the user equipment 121 may comprise a processing circuitry 510, which may also be referred to as processing module. The processing circuitry 510 may comprise one or more of the configuring module 511 and the transceiving module 512, and perform the function thereof as described below.

The user equipment 121 is configured to, or may comprise a configuring module 511 configured to, configure a request message for setting up a radio connection to a network node 110 to comprise an indication indicating whether the user equipment 121 has one or more differing user equipment radio capabilities in relation to another user equipment 122 configured to be in the radio communications network 100. The user equipment 121 is also configured to, or may comprise a transceiving module 512 configured to, send the configured request message to the network node 110.

In some embodiments, the request message may be a RRCConnectionRequest message in a Evolved Universal Terrestrial Radio Access Network, E-UTRAN, RRC Connection Setup procedure. For example, as defined in 3GPP TS36.331 “Evolved Universal Terrestrial Radio Access (E-UTRA); Radio Resource Control (RRC); Protocol Specification”.

In some embodiments, the user equipment 121 may be configured to, or may comprise a configuring module 511 configured to, configure the request message such that the indication further indicates at least one of the one or more differing user equipment radio capabilities. In some embodiments, the user equipment 121 may be configured to, or may comprise a configuring module 511 configured to, replace information bits in the InitialUE-Identity IE in the RRCConnectionRequest message with information bits comprising the indication. In some embodiments, the replaced information bits are information bits which correspond to the Mobility Management Entity Code, MMEC. Here, the replaced information bits to the network node 110 may be provided later by the user equipment 121 in a RRCConnectionSetupComplete message in the E-UTRAN RRC Connection Setup procedure.

In some embodiments, the user equipment 121 may be configured to, or may comprise a configuring module 511 configured to, configure the indication in the criticalExtensionFuture Information Element, IE, of the RRCConnectionRequest message. Alternatively, the user equipment 121 may be configured to, or may comprise a configuring module 511 configured to, configure the indication as a dedicated RRCConnectionRequest message defined in a message on the Uplink Common Control CHannel, UL-CCCH-Message, used for transporting RRCConnectionRequest messages.

In some embodiments, the user equipment 121 may be configured to, or may comprise a transceiving module 512 configured to, receive information in a broadcast message from the network node 110 indicating that the user equipment 121 is to perform the configuration and sending of the request message when setting up a radio connection to the network node 110. In some embodiments, the user equipment 121 may be configured to, or may comprise a transceiving module 512 configured to, send a conventional RRCConnectionRequest message without any of the indications in a E-UTRAN RRC Connection Setup procedure when the configuration and sending of the request message results in one or more failures of setting up the radio connection to the network node 110.

The embodiments for requesting a radio connection with a network node 110 in a radio communications network 100 may be implemented through one or more processors, such as, e.g. the processing circuitry 510 in the user equipment 121 depicted in FIG. 5, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 510 in the user equipment 121. The computer program code may e.g. be provided as pure program code in the user equipment 121 or on a server and downloaded to the user equipment 121. The carrier may be one of an electronic signal, optical signal, radio signal, or computer readable storage medium, such as, e.g. electronic memories like a RAM, a ROM, a Flash memory, a magnetic tape, a CD-ROM, a DVD, a Blueray disc, etc.

Thus, the user equipment 121 may further comprise a memory 520, which may be referred to or comprise one or more memory modules or units. The memory 520 may be arranged to be used to store executable instructions and data to perform the methods described herein when being executed in the user equipment 121. Those skilled in the art will also appreciate that the processing circuitry 510 and the memory 520 described above may refer to a combination of analog and digital circuits, and/or one or more processors configured with software and/or firmware, e.g. stored in the memory 520, that when executed by the one or more processors such as the processing circuitry 510 perform the method as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, a computer program, comprising instructions which, when executed on at least one processor, e.g. the processing circuitry or module 510, cause the at least one processor to carry out the method for handling communications in a radio communications network 100 as described above is presented. Also, a carrier containing the computer program, wherein the carrier is one of an electronic signal, optical signal, radio signal, or computer readable storage medium, is presented.

To perform the method actions in the network node 110 for enabling a radio connection with a user equipment 121 in a radio communications network 100, the network node 110 may comprise the following arrangement depicted in FIG. 6. The network node 110 is configured to be in the radio communications network 100.

FIG. 6 shows a schematic block diagram of embodiments of the network node 110. In some embodiments, the network node 110 may comprise a transceiving module 611, a configuring module 612, and a use module 613. In some embodiments, the network node 110 may comprise a processing circuitry 610, which may also be referred to as processing module. The processing circuitry 610 may comprise one or more of the transceiving module 611, the configuring module 612, and the use module 613, and perform the function thereof as described below.

The network node 110 is configured to, or may comprise a transceiving module 611 configured to, receive a request message for setting up a radio connection from the user equipment 121 comprising an indication indicating whether the user equipment 121 has one or more differing user equipment radio capabilities in relation to another user equipment 122 configured to be in the radio communications network 100.

In some embodiments, the indication further indicates at least one of the one or more differing user equipment radio capabilities. In some embodiments, the network node 110 may further be configured to, or may comprise a use module 613 configured to, use radio resources based on the indication when setting up the radio connection.

In some embodiments, the network node 110 may be configured to, or may comprise a configuring module 612 configured to, configure a broadcast message indicating to the user equipment 121 to configure a request message, when setting up a radio connection to the network node 110, to comprise the indication and send the configured request message to the network node 110. Here, the network node 110 may also be configured to, or may comprise a transceiving module 611 configured to, send the configured broadcast message to the user equipment 121.

In some embodiments, the broadcast message may be comprised in a System Information Block, SIB or SIBx, or a Master Information Block, MIB.

The embodiments for enabling a radio connection with a user equipment 121 in a radio communications network 100 may be implemented through one or more processors, such as, e.g. the processing circuitry 610 in the network node 110 depicted in FIG. 6, together with computer program code for performing the functions and actions of the embodiments herein. The program code mentioned above may also be provided as a computer program product, for instance in the form of a data carrier carrying computer program code or code means for performing the embodiments herein when being loaded into the processing circuitry 610 in the network node 110. The computer program code may e.g. be provided as pure program code in the network node 110 or on a server and downloaded to the network node 110. The carrier may be one of an electronic signal, optical signal, radio signal, or computer readable storage medium, such as, e.g. electronic memories like a RAM, a ROM, a Flash memory, a magnetic tape, a CD-ROM, a DVD, a Blueray disc, etc.

Thus, the network node 110 may further comprise a memory 620, which may be referred to or comprise one or more memory modules or units. The memory 620 may be arranged to be used to store executable instructions and data to perform the methods described herein when being executed in the network node 110. Those skilled in the art will also appreciate that the processing circuitry 610 and the memory 620 described above may refer to a combination of analog and digital circuits, and/or one or more processors configured with software and/or firmware, e.g. stored in the memory 620, that when executed by the one or more processors such as the processing circuitry 610 perform the method as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

Thus, a computer program, comprising instructions which, when executed on at least one processor, e.g. the processing circuitry or module 610, cause the at least one processor to carry out the method for handling communications in a radio communications network 100 as described above is presented. Also, a carrier containing the computer program, wherein the carrier is one of an electronic signal, optical signal, radio signal, or computer readable storage medium, is presented.

It should be noted that an advantage with the embodiments described above is that they enable application in both future radio communication networks, as well as, application existing legacy networks and user equipments, i.e. backward-compatible.

The terminology used in the detailed description of the particular exemplary embodiments illustrated in the accompanying drawings is not intended to be limiting of the described methods, user equipments 121 and network nodes 110, which instead should be construed in view of the enclosed claims.

As used herein, the term “and/or” comprises any and all combinations of one or more of the associated listed items.

Further, as used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation. The common abbreviation “etc.”, which derives from the Latin expression “et cetera” meaning “and other things” or “and so on” may have been used herein to indicate that further features, similar to the ones that have just been enumerated, exist.

As used herein, the singular forms “a”, “an” and “the” are intended to comprise also the plural forms as well, unless expressly stated otherwise. It will be further understood that the terms “includes,” “comprises,” “including” and/or “comprising,” when used in this specification, specify the presence of stated features, actions, integers, steps, operations, elements, and/or components, but do not preclude the presence or addition of one or more other features, actions, integers, steps, operations, elements, components, and/or groups thereof.

Unless otherwise defined, all terms comprising technical and scientific terms used herein have the same meaning as commonly understood by one of ordinary skill in the art to which the described embodiments belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The embodiments herein are not limited to the above described preferred embodiments. Various alternatives, modifications and equivalents may be used. Therefore, the above embodiments should not be construed as limiting.

### ABBREVIATIONS

ASN Abstract Syntax Notation
IE Information Element
LTE Long Term Evolution
MCS Modulation and Coding Scheme
MIB Master Information Block
MME Mobility Management Entity
MMEC MME Code
MSG Message
MTC Machine Type Communications
NW Network
PCI Physical Cell Identity
RACH Random Access CHannel
RRC Radio Resource Control
SAE System Architecture Evolution
SIB System Information Block
TBS Transport Block Size
TMSI Temporary Mobile Subscription Identity
UE User Equipment
3GPP 3^{rd} Generation Partnership Project

1. A method performed by a user equipment for requesting a radio connection with a network node in a radio communications network, the user equipment being configured to be in the radio communications network, the method comprising:
configuring a request message for setting up a radio connection to a network node to comprise an indication indicating whether the user equipment has at least one differing user equipment radio capability in relation to another user equipment configured to be in the radio communications network; and
sending the configured request message to the network node.

2. The method according to claim 1, wherein the request message is a RRCConnectionRequest message in an Evolved Universal Terrestrial Radio Access Network (E-UTRAN) RRC Connection Setup procedure.

3. The method according to claim 1, wherein the configuring comprises configuring the request message such that the indication further indicates at least one of the at least one differing user equipment radio capability.

4. The method according to claim 3, wherein the configuring further comprises replacing information bits in the InitialUE-Identity IE in the RRCConnectionRequest message with information bits comprising the indication.

5. The method according to claim 4, wherein the replaced information bits are information bits which correspond to the Mobility Management Entity Code (MMEC).

6. The method according to claim 1, wherein the configuring further comprises configuring the indication using a criticalExtensionFuture Information Element (IE) in the RRCConnectionRequest message.

7. The method according to claim 1, wherein the configuring further comprises configuring the indication as a dedicated RRCConnectionRequest message defined in a message on the Uplink Common Control Channel (UL-CCCH-Message) used for transporting RRCConnectionRequest messages.

8. The method according to claim 1, further comprising:
receiving information in a broadcast message from the network node indicating that the user equipment is to perform the configuring and sending when setting up a radio connection to the network node.

9. The method according to claim 1, further comprising, when performing the configuring and sending results in at least one failure of setting up the radio connection to the network node, sending a conventional RRCConnectionRequest message without the indication in a E-UTRAN RRC Connection Setup procedure.

10. A user equipment for requesting a radio connection with a network node in a radio communications network, the user equipment being configured to be in the radio communications network, the user equipment is further configured to:
configure a request message for setting up a radio connection to a network node to comprise an indication indicating whether the user equipment has at least one differing user equipment radio capability in relation to another user equipment configured to be in the radio communications network; and
send the configured request message to the network node.

11. The user equipment according to claim 10, wherein the request message is a RRCConnectionRequest message in an Evolved Universal Terrestrial Radio Access Network (E-UTRAN) RRC Connection Setup procedure.

12. The user equipment according to claim 10, further configured to configure the request message such that the indication further indicates at least one of the at least one differing user equipment radio capability.

13. The user equipment according to claim 12, further configured to replace information bits in the InitialUE-Identity IE in the RRCConnectionRequest message with information bits comprising the indication.

14. The user equipment according to claim 13, wherein the replaced information bits are information bits which correspond to the Mobility Management Entity Code (MMEC).

15. The user equipment according to claim 10, further configured to configure the indication using a criticalExtensionFuture Information Element in the RRCConnectionRequest message.

16. The user equipment according to claim 10, further configured to configure the indication as a dedicated RRCConnectionRequest message defined in a message on the Uplink Common Control Channel (UL-CCCH-Message) used for transporting RRCConnectionRequest messages.

17. The user equipment according to claim 10, further configured to receive information in a broadcast message from the network node indicating that the user equipment is to perform the configuration and sending of the request message when setting up a radio connection to the network node.

18. The user equipment according claim 10, further configured to send a conventional RRCConnectionRequest message without the indication in a E-UTRAN RRC Connection Setup procedure when the configuration and sending of the request message results in at least one failure of setting up the radio connection to the network node.

19. A method performed by a network node for enabling a radio connection with a user equipment in a radio communications network, the network node being configured to be in the radio communications network, the method comprising:
receiving a request message for setting up a radio connection from the user equipment, the request message comprising an indication indicating whether the user equipment has at least one differing user equipment radio capability in relation to another user equipment configured to be in the radio communications network.

20. The method according to claim 19, wherein the indication further indicates at least one of the at least one differing user equipment radio capability.

21. The method according to claim 19, further comprising:
using radio resources based on the indication when setting up the radio connection.

22. The method according to claim 19, further comprising:
configuring a broadcast message indicating to the user equipment to configure a request message, when setting up a radio connection to the network node, to comprise the indication and to send the configured request message to the network node; and
sending the configured broadcast message to the user equipment.

23. The method according to claim 19, wherein the broadcast message is comprised in one of a System Information Block, (SIB or SIBx), and a Master Information Block (MIB).

24. A network node for enabling a radio connection with a user equipment in a radio communications network, the network node being configured to be in the radio communications network, the network node being further configured to:
receive a request message for setting up a radio connection from the user equipment, the request message comprising an indication indicating whether the user equipment has at least one differing user equipment radio capability in relation to another user equipment configured to be in the radio communications network.

25. The network node according to claim 24, wherein the indication further indicates at least one of the at least one differing user equipment radio capability.

26. The network node according to claim 24, further configured to use radio resources based on the indication when setting up the radio connection.

27. The network node according to claim 24, further configured to configure a broadcast message indicating to the user equipment to configure a request message, when setting up a radio connection to the network node, to comprise the indication and to send the configured request message to the network node, and to send the configured broadcast message to the user equipment.

28. The network node according to claim 24, wherein the broadcast message is comprised in one of a System Information Block, (SIB or SIBx), and a Master Information Block (MIB).
